(19) United States
(12) Patent Application Publication
(10) Pub. No.: US 2005/0116370 A1
(43) Pub. Date: Jun. 2, 2005

(54) Imprinting machine and imprinting method

(76) Inventors: Masahiko Ogino, Hitachi (JP); Akihiro Miyauchi, Hitachi (JP); Kousuke Kuwabara, Hitachi (JP); Takashi Ando, Hitachi (JP); Kazuo Takahashi, Kudamatsu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/997,865

(22) Filed: Nov. 29, 2004

(30) Foreign Application Priority Data
Nov. 27, 2003 (JP) 2003-397108

(51) Int. Cl. B29C 35/08

(52) U.S. Cl. 264/40.1; 264/496; 264/322; 249/140

(57) ABSTRACT

An object of the invention is to execute an imprinting process at a higher speed and a higher accuracy, in an imprinting apparatus. In an imprinting apparatus for contacting and pressurizing a mold having a micro concavo-convex structure formed on a surface thereof to a substrate surface in order to form a micro and nanometer size structure on a substrate, a step of pressurizing the mold and the substrate and a step of peeling the mold from the substrate are constituted by independent units, the mold and the substrate are moved in a closely attached state at a time of moving from the pressurizing step to the peeling step, and preferably at least two sets of molds and substrates are processed by the different steps simultaneously or a temporarily overlapped manner.

### TECHNICAL FIELD

The present invention relates to an imprinting method of forming a micro and nano structure body on a substrate by using a mold in which micro concavity and convexity having a nanometer unit or a micrometer unit is formed on a surface, and an imprinting machine for executing the method.

### BACKGROUND ART

In recent years, micronization and integration of a semiconductor integrated circuit are developed, and a high precision of a photolithography apparatus is promoted as a pattern imprinting technique for achieving a micro-fabrication. However, a working method gets close to a wavelength of a light source of a light exposure, and the lithography technique gets close to a limit. Accordingly, in order to accelerate further the micronization and the high precision, an electron beam drawing apparatus corresponding to a kind of charged particle beam apparatus is employed in place of the lithography technique.

A pattern formation using an electron beam employs a method of drawing a mask pattern as is different from a one-shot exposing method in a pattern formation using a light source such as an i beam, an exchange laser or the like. Accordingly, the more the pattern to be drawn is, the more the exposing (drawing) time is, so that there is a disadvantage that a lot of time is required for forming a pattern. Therefore, in proportion as an integration degree is dramatically increased to 256 megabyte, 1 gigabyte and 4 gigabyte, a pattern forming time is dramatically improved by just that much, so that there is a fear that a throughput is significantly deteriorated. Then, in order to speed up an electron beam drawing apparatus, there has been promoted a development of a batch graphic irradiating method of combining masks having various shapes and irradiating an electron beam in a lump thereto so as to form the electron beam having a complex shape. As a result, it is necessary to make the electron beam drawing apparatus large in size while the micronization of the pattern is promoted. In addition, a mechanism of accurately controlling a mask position is required. Accordingly, there is a disadvantage that a cost of the apparatus is increased.

On the contrary, a technique for executing a micro pattern formation at a low cost is disclosed in the following patent document 1 (U.S. Pat. No. 5,259,926) and patent document 2 (U.S. Pat. No. 5,772,905), non patent document 1 (S. Y. Chou et al, Appl. Phys. Lett., vol. 67, p.p. 3114-3116 (1995)) and the like. This technique is structured such that a predetermined pattern is imprinted by stamping a mold having the same concavo-convex pattern as a pattern to be formed on a substrate to a resist membrane layer formed a surface of an imprinted substrate. In particular, in accordance with a nanometer imprint technique described in the patent document 2 and the non patent document 1, a silicone wafer is used as the mold, and the micro and nano structure equal to or smaller than 25 nanometer can be formed in accordance with an imprinting.

Further, with respect to a press machine for pressurizing, there is disclosed in patent document 3 (JP-A-2000-254799) and the like a technique in which a stage positioning accuracy and a pressuring force are both achieved by using a screw pressurizing apparatus and a hydraulic pressurizing apparatus together. Further, there is disclosed in patent document 4 (JP-A-2003-527248) a technique of maintaining a parallel relation between the mold and the substrate highly.

In the conventional imprinting apparatus of the micro and nano structure, the mold in which the pattern is directly formed is fixed to a head side heat block within a vacuum chamber, and a substrate in which a polystyrene resin membrane having a thickness of 500 nm is formed, for example, on 6 inch φ silicone wafer is adsorbed onto a stage side heat block under a vacuum condition. Next, the mold and the substrate are aligned. Next, the mold and the substrate are closely attached by increasing a pressure within a hydraulic press cylinder and lifting up a hydraulic press lot, a vacuum deaeration is executed, and thereafter a pressurization is executed by energizing the stage side heat block and the head side heat block. Since the substrate and the heat block are fixed continuously by a peeling apparatus, there is a problem that steps after the pressurization, for example, a peeling step, a inspecting step of the mold, a cleaning step and the like, are all brought under control, and a throughput is extremely deteriorated.

### DISCLOSURE OF THE INVENTION

The present invention provides a technique for imprinting at a higher speed and a higher accuracy on the basis of an imprint technique by which a micro pattern can be formed. Further, an object of the present invention is to execute an imprinting at a higher speed and a higher accuracy in an imprint method corresponding to a pattern imprinting technique for forming a structure body having a micro shape, in a manufacturing step for a biological device, a semiconductor device, a storage media and the like.

The inventors of the present invention have considered that the imprinting can not be executed at a high speed because the pressurization and the peeling of the substrate and the mold are executed within one unit. In other words, the present invention is structured such that in order to form a micro and nanometer size structure on a substrate, it is possible to execute a step of contacting and pressurizing a mold having a micro concavo-convex structure formed on a surface thereof onto a surface of a substrate which can keep a plasticity as occasion demands so as to imprint the micro concavo-convex structure of the mold to the substrate surface, a step of peeling the mold and the substrate surface, and the like, by independent units, whereby it is possible to execute the respective steps without being constrained by the other processes. Further, since the mode and the substrate can be integrally moved at a time of moving from the imprinting step to the peeling step, a preparing work in the peeling step is not required, or significantly simplified, and a throughput is significantly improved. Accordingly, since two or more sets of molds and substrates can be approximately simultaneously processed by the different units, it is possible to significantly improve the throughput of the imprinting process.

The present invention provides a micro and nanometer size structure imprinting method comprising:
a step of contacting and pressurizing a mold having a micro concavo-convex structure formed on a surface thereof onto a substrate having a surface made of a material capable of keeping a plasticity as occasion demands so as to imprint the micro concavo-convex structure to the surface; and
a step of peeling the mold from the surface,
wherein the mode and the substrate are integrally moved between the steps. The material is held on the substrate surface. The material may be constituted by a photo cure type resin composition material, a thermoplastic resin, a glass or a metal.

The present invention provides a micro and nanometer size structure imprinting method having a step of heating the material such as the thermoplastic resin, the glass or the metal formed on the substrate to a glass transition temperature or a softening point or more so as to keep the plasticity of the material prior to the imprinting step.

The present invention provides a micro and nanometer size structure imprinting method, wherein at least a part of the mold has a light permeability, the resin composition material is cured by irradiating the light via a light permeable portion of the mold after pressurizing the mold to the photo cure type resin composition material formed on the substrate, and a development is executed by removing an uncured portion.

The present invention further provides an imprinting apparatus comprising:
a contacting and holding means for contacting and holding a mold having a micro concavo-convex structure on a surface thereof onto a substrate surface having a material capable of keeping a plasticity as occasion demands;
a pressurizing means for applying a pressure to a contact surface between the mold and the substrate; and
a peeling means for peeling the mold from the substrate surface,
wherein the mold and the substrate are integrally moved at a time of moving the mold and the substrate from the pressurizing means to the peeling means.

The present invention further provides an imprinting apparatus comprising:
an alignment unit for determining a relative position between a substrate and a mold;
a pressurizing unit for pressurizing the substrate and the mold;
a peeling unit for peeling the mold from the substrate;
a storing unit for storing the mold;
a carrying in and carrying out unit for carrying in and carrying out the substrate;
an inspection unit of the metal mold and the imprinted substrate; and
a conveying unit for conveying the mold and the substrate between the respective units. It is preferable that two or more, in particular, all of the units constituting the imprinting apparatus are arranged on the periphery of the conveying apparatus. It is possible to provide an imprinting apparatus in which a plurality of molds having different patterns are stored in the storing unit.

The structure can be made such that the pressurizing unit has a heating mechanism. The structure can be made such that the pressurizing unit has a light irradiating mechanism. The structure can be made such that the mold is made of a metal or an inorganic material. The present invention further provides an imprinting apparatus comprising:
an imprinting unit for contacting and pressurizing a mold having a micro concavo-convex structure formed on a surface thereof onto a substrate surface;
an alignment unit for determining a relative position between the substrate and the mold;
a pressurizing unit for pressurizing the substrate and the mold;
a peeling unit for peeling the mold from the substrate;
a storing unit for storing the mold; and
a carrying in and carrying out unit for carrying in and carrying out the substrate;
wherein a control apparatus is provided so as to control such that two or more sets of molds and substrates are processed by the different units.

The present invention provides an imprinting apparatus comprising:
an imprinting unit for contacting and pressurizing a mold having a micro concavo-convex structure formed on a surface thereof onto a substrate surface;
an elevating mechanism for sliding a stage portion on which the mold and the substrate are mounted; and
a pressurizing mechanism for applying a load to the substrate and the mold,
wherein the imprinting apparatus has a motor driving the elevating mechanism, and an air cylinder driving the pressurizing mechanism. The structure can be made such that the elevating mechanism is constituted by a screw thread shaft and a nut attached to a stage portion engaged with the screw thread shaft, and the stage portion is slid by rotating the screw thread portion by an electric motor. The structure can be made such that the elevating mechanism is constituted by two or more screw thread shafts, and the nuts attached to the stage portion engaged therewith, and the stage portion is slid by rotating the screw thread shaft by the electric motor. The structure can be made such that the pressurizing mechanism pressurizes to a predetermined pressure on the basis of at least two stages of steps.

It is preferable that the imprinting apparatus is constituted by an alignment unit for aligning a relative position between the substrate and the mold, a cleaning unit for cleaning the used mold, a storing unit for storing the mold, a carrying in and carrying out unit for carrying in and carrying out the substrate, and an inspection unit for inspecting the metal and the imprinted substrate, in addition to a pressuring unit for pressurizing the substrate and the mold, and the peeling unit for peeling the mold from the substrate. In accordance with the structure mentioned above, it is possible to simultaneously process plural pairs of molds and substrates, in the respective units, an imprinting efficiency is improved, and it is possible to execute an imprinting at a high speed.

Further, it is preferable that the inspection unit for the metal mold and the imprinted substrate has respective inspection data in common. In accordance with the structure, since it is possible to process a defective portion on the metal mold as a defective portion on the imprinted substrate, or it is possible to recognize the defective portion on the substrate as a defective portion such as a clogging, a breakage or the like on the metal mold, an accuracy of an imprinted shape management is improved. Further, it is preferable in view of effectively processing the substrate that the respective units are arranged around the conveying apparatus. Further, a plurality of molds are stored in the storing unit, and are appropriately selected and used in correspondence to the imprinted pattern. Further, in the case that the pressurizing unit has a heating mechanism, the concavo-convex shape of the mold can be imprinted to the substrate by heating the substrate and softening the material on the substrate surface at a time of pressurizing.

Further, in the case that the mold is made of a light permeable material such as a quartz or the like, the pressurizing unit has a light irradiating mechanism. It is possible to cure the resin on the substrate surface so as to imprint the pattern shape of the mold by applying a liquid photo cure type resin to the substrate surface, thereafter pressurizing the light permeable mold to the substrate and irradiating the light.

Further, the inventors of the present invention have considered that a reduction in time necessary for making a mask is prevented, in connection with a method of preparing a mold used for the present invention because an alignment of a pattern shape design and a mask making step is defective. The object is solved by a method including a step of using a computer for designing a pattern shape, and a step of preparing an original plate and a step of attaching a jig holding the original plate, wherein a process for preparing the mold is automatically selected in correspondence to a size of the pattern shape and a prepared number. In the case that the pattern is constituted only by a size equal to or smaller than about 100 nm, it is preferable in the working method that an electron beam drawing method is employed for forming the resist pattern. Further, in the case that the pattern is constituted only by the pattern equal to or larger than 100 nm, it is preferable in view of improving a productivity to employ a photolithography. Further, in the case that there exist various patterns from the pattern equal to or smaller than 100 nm to the pattern equal to or larger than 100 nm, it is preferable to form the pattern on the basis of a method obtained by combining the electron beam drawing method and the photolithography method. Further, in the case of forming a plurality of molds having the same shape, it is preferable that a production efficiency of the mold is improved by preparing a copy from the substrate forming the resist pattern in accordance with a plating method or the original plate prepared in accordance with a dry etching after forming the resist pattern.

Further, the inventors of the present invention have considered executing the imprinting at a high accuracy is prevented, in connection with a press machine for pressurizing the substrate and the mold because the hydraulic mechanism is used for obtaining a driving force for pressurizing. In other words, in an imprinting apparatus contacting and pressurizing a mold having a micro concavo-convex structure formed on a surface thereof onto a substrate surface for forming a micro and nanometer size structure on the substrate, the imprinting apparatus is constituted by an elevating mechanism for sliding a stage portion for fixing the mold or the substrate, and a pressurizing mechanism applying a load to the substrate and the mold, the elevating mechanism has a motor serving as a power source, and the pressurizing mechanism has an air cylinder serving as a power source. It is possible to prevent an oil from leaking from a lot portion at a time of pressurizing such as in the hydraulic mechanism so as to fly in all direction in the air and pollute the substrate and the mold surface, by using the air cylinder in the pressurizing mechanism. As a result, the defect and the fault of the pattern are improved at a time of imprinting, and it is possible to imprint at a high accuracy.

In this case, the elevating mechanism is constituted by a screw thread shaft and a nut engaged with the screw thread shaft, and the stage portion is slid by rotating the screw thread portion by an electric motor. Accordingly, it is possible to align the stage position with the position in which the substrate and the mold are pressurized at a high accuracy before pressurizing, and it is possible to improve a mold displacement at a time of pressurizing.

Further, the elevating mechanism is constituted by two or more screw thread shafts, and the nuts engaged therewith, and the stage portion is slid by rotating the screw thread shaft by the electric motor. Accordingly, it is possible to slide the stage while keeping a parallel attitude at a high accuracy.

Further, the pressurizing mechanism pressurizes to a predetermined pressure on the basis of at least two stages of steps. Accordingly, it is possible to restrict a rapid pressure change generated in the substrate and the mold, and it is possible to prevent the substrate and the mold from being broken. Further, since two or more molds and substrates are simultaneously processed in the different steps, a processing speed of the substrate is improved. Further, the pressurizing unit is constituted by an elevating mechanism for sliding the stage portion, and a pressurizing mechanism for applying a load to the substrate and the mold, the elevating mechanism has a motor serving as a power source, and the pressurizing mechanism has an air cylinder serving as a power source. Accordingly, it is possible to improve the pollution on the substrate and the mold surface caused by the oil leakage from the lot portion at a time of pressurizing such as in the hydraulic mechanism. As a result, the defect of the pattern is improved at a time of imprinting, and it is possible to imprint at a high accuracy.

In accordance with the present invention, since the micro and nanometer size structure is formed on the substrate, the step of pressuring the mold and the substrate, and the step of peeling the mold from the substrate are constituted by the independent units, and the processes in the respective units can be independently executed by moving the mold and the substrate in the integrated state at a time of moving from the pressurizing step to the peeling step, the processing efficiency is improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic plan cross sectional view showing a structure of a micro and nanometer size structure imprinting apparatus in accordance with the present invention;

FIG. 2 is a side elevational schematic view showing a main portion of a substrate carrying in and carrying out unit in the imprinting apparatus in accordance with the present invention;

FIG. 3 is a side elevational schematic view showing a main portion of a mold storing unit in the imprinting apparatus in accordance with the present invention;

FIG. 4 is a side elevational schematic view showing a main portion of an alignment unit in the imprinting apparatus in accordance with the present invention;

FIG. 5 is a side elevational schematic view showing a main portion of a heating type pressurizing unit in the imprinting apparatus in accordance with the present invention;

FIG. 6 is a side elevational schematic view showing a main portion of a peeling unit in the imprinting apparatus in accordance with the present invention;

FIG. 7 is a side elevational schematic view showing a main portion of a mold cleaning unit in the imprinting apparatus in accordance with the present invention;

FIG. 8 is a process development view showing a relation between each of the units and a moving state of the mold and the substrate in the imprinting apparatus in accordance with the present invention;

FIG. 9 is a side elevational schematic view showing a main portion of a photo cure type pressuring unit in the imprinting apparatus in accordance with the present invention;

FIG. 10 is a plan schematic view showing an arrangement of the respective units in an imprinting apparatus in accordance with the other embodiment of the present invention;

FIG. 11 is a process development view showing a movement relation each of the units and the mold and the substrate in the imprinting apparatus in accordance with the present invention shown in FIG. 10;

FIG. 12 is a flow chart showing a flow of the mold, the substrate and an inspection data in the imprinting apparatus in accordance with the present invention;

FIG. 13 is a flow chart showing an aspect of manufacturing and receiving an order of the mold used in an imprinting method in accordance with the present invention;

FIG. 14 is a flow chart explaining an outline of the imprinting method to which the present invention is applied; and

FIG. 15 is a perspective view showing an outer appearance shape of a nanometer pillar obtained in accordance with the imprinting method.

### DESCRIPTION OF THE PREFERRED EMBODIMENTS

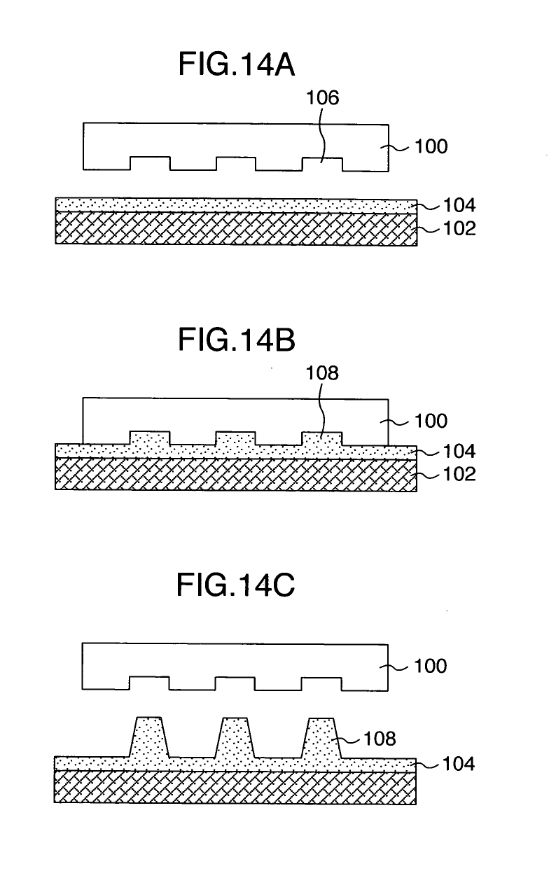

A description will be first given of a nanometer printing method with reference to FIGS. 14 and 15. A mold 100 having a micro concavo-convex pattern 106 is prepared on a surface of a silicone substrate or the like. Independently from the mold, on a substrate 102, there are provided with a resin membrane, a material having a plasticity such as a gold, a silver, a copper, a platinum or the like, or a material (for example, a glass, a metal or the like) 104 which can give the plasticity as occasion demands (FIG. 14A). The mold 100 is pressed on the plastic material 104 under a predetermined pressure at a temperature equal to or more than a softening point of the plastic material or a glass transition temperature (Tg) by using a press apparatus having a heating and pressurizing mechanism (not shown) (FIG. 14B). Accordingly, the plastic material enters into the micro concave portion of the mold, and a convex portion 108 is imprinted. The micro pattern of the mold is imprinted to the resin membrane on the substrate by cooling or curing the plastic material and thereafter peeling the mold 100 and the plastic material of the substrate (FIG. 14C). In FIG. 14C, the resin entering into the concave portion is drawn out in the peeling step of peeling the mold and the resin membrane, whereby there is a case that a micro projection group is formed at an aspect ration larger than an aspect ratio of the concavity and convexity of the mold.

Further, in place of the step of heating and curing, the structure may be made such that a photo cure type resin is employed, and the resin is cured by irradiating the light to the resin after pressuring and molding. At this time, it is possible to irradiate the light from the above of the light permeable mold after pressing, photo-cure the resin and develop so as to imprint the concavo-convex pattern of the mold, by using the light permeable mold such as the glass or the like.

The shape of the nanometer pillar (the micro projection group) formed in the manner mentioned above is affected by an employed plastic material, a concavo-convex shape of the mold, a pressurizing force, a temperature at a time of pressurizing, a time, a separating speed of the plastic material and the mold, and the like. Accordingly, the shape required for the micro and nanometer size structure may be changed in accordance with an intended use. FIG. 15 is a perspective view showing some types of micro projection groups or micro and nanometer size structures. FIG. 15A shows a typical shape obtained at a time of using a thermoplastic resin as the plastic material, in which the resin entering into an inner portion of the mold at a time of detaching the mold is drawn out, with respect to an aspect ratio (a ratio of a diameter D and a height H of the concavo-convex structure, H/D) of the concavo-convex structure formed in the mold, and an aspect ratio (2h/(d1+d2)) of the micro and nanometer size structure becomes larger than an aspect ratio of the concavo-convex structure formed in the mold, as shown in FIG. 15A. Of course, in the case of using the resin, it is possible to obtain the micro and nanometer size structure having an aspect ratio (h/d1) or (2h/(l1+l2)) nearly equal to that of the concavo-convex structure of the mold by selecting various conditions as occasion demands, as shown in FIG. 15B or 15C.

As described above, one of the most important requirements in the imprinting method is a design of the mold. It is necessary to suitably design the mold in accordance with the used plastic material, the size, particularly the depth of the concavo-convex structure, the imprinting condition and the like.

In accordance with the nanometer printing method, there can be obtained features (1) an integrated extra micro pattern can be efficiently imprinted, (2) a cost of the apparatus is inexpensive, (3) the apparatus can be applied to a complex shape and can form a pillar or the like, and the like. In order to make best use of the features of the imprinting method as mentioned above, it is necessary to consider a designing method of the mold.

The nanometer printing method is applied to the following fields.
(1) Various biological devices
(2) Analyzing apparatus of immune system such as DNA chip or the like, disposable DNA chip and the like
(3) Semiconductor multilayer interconnection
(4) Printed circuit board or RF MEMS
(5) Optical or magnetic storage
(6) Optical device such as waveguide, diffraction grating, micro lens, polarizing element and the like, and photonic crystal
(7) color sheet
(8) LCD display
(9) FED display

In the present invention, the nanometer print means the imprinting of the concavo-convex structure in a range that a cross sectional area of the concavo-convex structure of the imprinted mold is about some hundreds μm to some nm, in particular, in a range of submicron (smaller than 1 μm). Further, in the present invention, the mold has the micro pattern to be imprinted, and the method of forming the pattern on the mold is not particularly limited. The method can be selected in correspondence to a desired processing accuracy, for example, a photolithography, an electron beam drawing method and the like are selected. As a material of the mold, it is possible to employ any material such as a silicone wafer, various metal materials, a glass, a quartz, a ceramic, a plastic and the like, as far as a strength and a workability having a required accuracy are satisfied. In specific, Si, SiC, SiN, polycrystalline Si, glass, Ni, Cr, Cu and material including at least one of them are preferably exemplified. Further, it is preferable that a mold release treatment for preventing an adhesion to the resin is applied to the surface of the mold. A fluoric coupling agent is preferable as a surface treating agent in addition to the silicone mold releasing agent.

In the present invention, the material forming the substrate is not particularly limited, but a material having a predetermined strength is preferable. In specific, the silicone, the various metal materials, the glass, the ceramic, the plastic and the like are exemplified.

In the present invention, the material of the substrate imprinting the micro concavo-convex structure of the mold or the material held to the substrate is constituted by a soft material which can be deformed in accordance with the concavo-convex structure of the mold at normal temperatures and normal pressures or in a heated state. The substrate itself may be made of the material mentioned above, or the material mentioned above may be held on the surface of the substrate. The material is structured such that a plasticity is applied by heating or the like at the normal temperatures and normal pressures or the impressing step as occasion demands. The material includes various synthetic resins, for example, a thermoplastic resin, a photo cure type resin, a glass having a lower softening point than that of the material of the mold, and the like. The substrate is formed by the material itself, or the material mentioned above is fixed or held to the surface or a part of the surface of other substrate made of a soft metal, for example, the gold, the silver, the copper, the platinum, the aluminum or the like, in accordance with an adhering method, a crimping method, a fitting method or the like. The material held to the substrate may be detached after imprinting.

The thermoplastic resin to which the micro and nanometer size structure is imprinted is not particularly limited, however, may be selected in accordance with a desired working accuracy. In specific, it is possible to employ a thermoplastic resin such as a polyethylene, a polypropylene, a polyvinyl alcohol, a poly vinylidene chloride, a polyethylene terephthalate, a polyvinyl chloride, a polystyrene, an ABS resin, an AS resin, an acrylic resin, a polyamide, a polyacetal, a polybutylene terphthalate, a glass reinforced polyethylene terephthalate, a polycarbonate, a modified polyphenylene ether, a polyphenylene sulfide, a polyether ether ketone, a liquid crystal polymer, a fluorine resin, a polyalate, a polysulfone, a polyether sulfone, a polyamide imide, a polyether imide, a thermoplastic polyimide and the like, a thermosetting resin such as a phenyl resin, a melamine resin, a urea resin, an epoxy resin, an unsaturated polyester resin, an alkyd resin, a silicone resin, a diallyl phthalate resin, a polyamidevismalymide, a plyvisamide triazole and the like, and a material obtained by blending two or more kinds of these materials. A thickness of the resin membrane is from some nm to some ten μm, however, no problem is generated if the thickness is larger than this.

In the present invention, the mold and the substrate are heated at a time of pressuring the substrate and the mold in the step of pressurizing the mold and the substrate, however, it is possible to employ a heating wire, an inductive heater, and an infrared heater as a method thereof. At this time, it is preferable that a heating temperature is equal to or more than Tg of the imprinted resin. In the case of using the photo cure type resin and the transparent mold, the resin is cured by irradiating the light by a light irradiating apparatus such as an extra high pressure mercury lamp, a xenon lamp and the like. Further, it is more preferable in view of inhibiting void from being generated at a time of imprinting to execute the step of pressuring the mold and the substrate under a vacuum condition.

In the present invention, it is possible to employ a vacuum adsorption for fixing the mold and the substrate, in the step of peeling the mold and the substrate. Further, the mold and the substrate are peeled by inserting a wedge-shaped jig having a sharp leading end to an interface in which the mold and the substrate are closely attached. Further, it is possible to easily peel the mold and the substrate by pulling the mold and the substrate from one direction in a state of keeping a predetermined angle. At this time, there is a case that a mechanism of spraying an air, a nitrogen or the like exists in a peeling interface of the substrate and the mold. In addition, it is more preferable in view of controlling the peeling that the peeling unit is provided with a heater or a cooling apparatus and a peeling speed control mechanism for controlling the temperature of the substrate and the mold at a time of peeling.

In the present invention, it is more preferable in view of achieving an accurate position control of the stage that the motor used in the elevating mechanism is constituted by a motor such as a step motor which can control a rotation number, a rotating speed and the like.

In the present invention, the air cylinder used in the pressurizing mechanism is structured such as to control a final thrust by driving on the basis of a Pascal's principle and controlling an original pressure.

In the present invention, it is preferable that the movement of the mold and the substrate between the respective units has a mechanism which can hold the substrate and the mold in the leading end, and move them in a three-dimensional manner.

In the present invention, the alignment unit observes alignment marks formed on the substrate surface and the mold surface by a microscope obtained by combining a lens or the like and a CCD, and contacting the substrate and the mold after aligning a relative position thereof. At this time, a laser may be used for recognizing the alignment marks or the like.

In the present invention, the cleaning unit is a unit for removing the resin and the foreign material attached to the mold surface, and is preferably provided, in specific, with a mechanism of dipping the mold into a tank filled with an organic solvent or the like, cleaning the mold by applying an ultrasonic wave or the like, thereafter rinsing and drying. Alternatively, the resin and the foreign material can be removed by exposing the mold to an oxygen plasma.

In the present invention, it is preferable that the storing unit is stored in a stacked state in order to efficiently store a plurality of molds. Further, the molds are taken in and out automatically by a robot arm or the like. Further, in order to prevent the foreign material from being attached to the mold surface during taking in and out the mold and storing the mold, it is preferable to store in a state in which the mold surface is directed toward a gravitational direction. Further, plural sets of molds having a plurality of same patterns are stored in the storing unit. Accordingly, a plurality of molds can be utilized simultaneously in a plurality of steps.

In the present invention, the inspecting unit of the metal mold and the imprinted substrate detects the defect portion by using a detecting device using an electron, an electromagnetic wave, a laser beam, an infrared ray, a fluorescent light, a visible light or the like, a microscope and the like. The inspecting units can alarm a disposition and a cleaning process of the mold by having the respectively acquired inspection date in common, thereby previously sensing the portion where the defect will be generated, and the breakage and the pollution generated in the metal mold at a time of imprinting, and is preferable in view of improving an accuracy of a quality control.

In the present invention, it is preferable in view of shortening the mold and substrate moving time in the imprinting step and saving the apparatus space that the respective units are arranged around the conveying apparatus. However, the arrangement is not limited to this. The arrangement can be appropriately changed in accordance with a placed environment and condition such as a linear arrangement, an L-shaped arrangement, a C-shaped arrangement and the like.

A description will be given below of an embodiment in accordance with the present invention.

### Embodiment 1

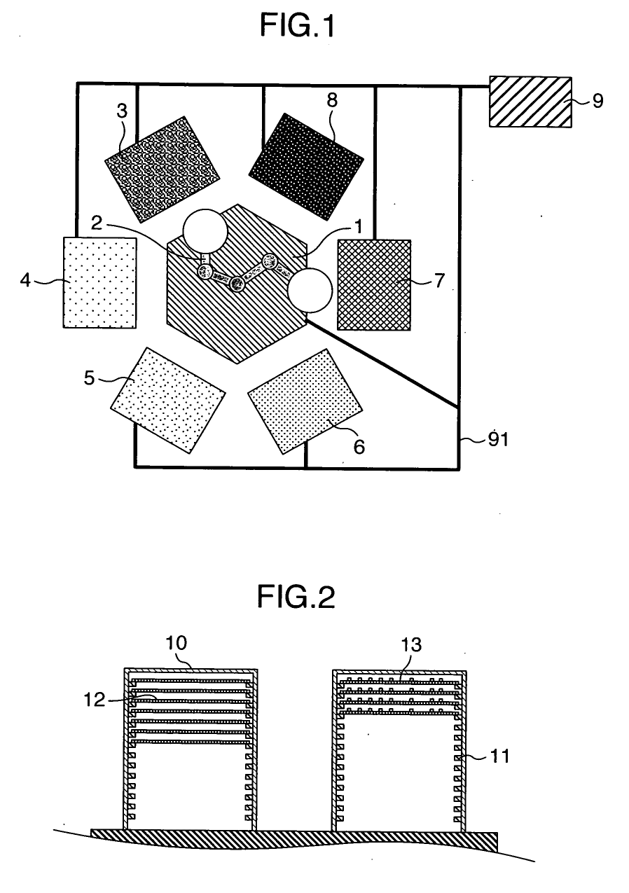

FIG. 1 shows a schematic plan view of an arrangement of the respective units of the imprinting apparatus in accordance with the present invention. The following micro pattern imprinting experiments are executed by using the imprinting apparatus in accordance with the present embodiment.

The present imprinting apparatus is constituted by a substrate carrying in and carrying out unit 3, a mold storing unit 4, an alignment unit 5, a pressurizing unit 6, a peeling unit 7 and a mold cleaning unit 8, which are arranged around a conveying unit 1. Further, the respective units are connected to a control unit 9 by a connecting cable 91. In the substrate carrying in and carrying out unit 3, there are set a plurality of substrates (not shown) in which a polystyrene resin membrane having a thickness of 500 nm is formed on a silicone wafer having a diameter of 6 inch φ. The substrate is moved to each of the units in accordance with each of the steps by a robot arm 2.

A description will be given of an imprinting method executed by the imprinting apparatus in accordance with the present invention. FIG. 2 shows a side cross sectional schematic view of a main portion of the substrate carrying in and carrying out unit 3. There is arranged a substrate rack 11 in which a plurality of unprocessed substrates 12 are set, and a processed goods carrying out rack 11 in which processed substrates 12 already having the micro patterns imprinted on the substrate surface are stored. These racks can be detached from the unit, and the substrates are carried in and the processed goods are carried out per the racks. The number of the substrates and the processed goods within the rack are always managed by the control unit 9, the substrates and the processed goods are appropriately supplemented and carried out.

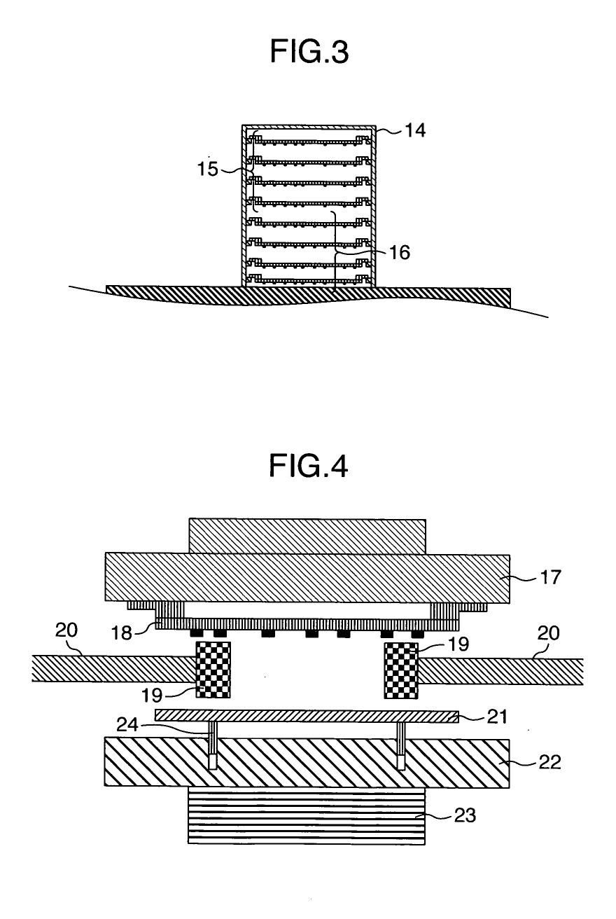

FIG. 3 shows a cross sectional schematic view of a main portion of the mold storing unit 4. a plurality of first molds 15 and second molds 16 having different patterns are stored in a mold rack 14 in a state in which the pattern forming surfaces are directed downward. The micro concavo-convex pattern on the mold surface is prepared by forming a thermal oxidative membrane of 500 nm on a silicone wafer of 6 inch, and forming in accordance with a dry etching method after forming a resist pattern by utilizing an EB drawing method. The pattern dimension is constituted by a depth of 500 nm, a minimum L/S of 100 nm/100 nm, and a minimum via hole diameter of 100 nm, and a processed area is within 5 inch φ of the mold surface. The mold is formed by attaching a guide ring for conveying to the 6 inch wafer processed in accordance with the method mentioned above. The kind, the number and the like of the molds within the mold storing unit are always monitored and managed by the control unit. Further, since the mold rack 14 is detachable, the molds are replaced per the rack.

FIG. 4 shows a side cross sectional schematic view of a main portion of the alignment unit 5. A substrate 21 in which the polystyrene membrane of 500 nm is formed on the silicone water of 6 inch is set on a stage 22 from the substrate carrying in and carrying out unit 3 by the robot arm 2 of the conveying unit 1 in FIG. 1. At this time, a push-up pin 24 is lifted up and supports the substrate 21, the push-up pin is moved downward after the robot arm is retracted, whereby the substrate 21 is vacuum-adsorbed onto the stage. Next, the mold is conveyed from the mold storing unit 4, and is set to a mold holder 17 on the basis of a vacuum adsorption.

Next, alignment marks on the mold 18 and the substrate 21 are recognized by a CCD camera 19 with a microscope which is attached to a leading end of a CCD camera fixing arm 20 and can be switched between 250 magnifications and 3300 magnifications. Further, the mold 18 and the substrate 21 are aligned by moving the stage 22 by means of an XYZΘ moving mechanism 23. The XYZΘ moving mechanism 23 is constituted by a stepping motor for a rough movement and a 6-axes piezo element for a fine adjustment.

The stage 22 is moved upward at a time when the alignment is finished, the mold 18 and the substrate 21 are closely attached, and thereafter, the mold 18 is disconnected from the mold holder 17. Further, a gap is formed between the substrate and the stage by moving upward the push-up pin 24, and the substrate/mold are held by the robot arm 2, and thereafter is moved to the next pressurizing unit.

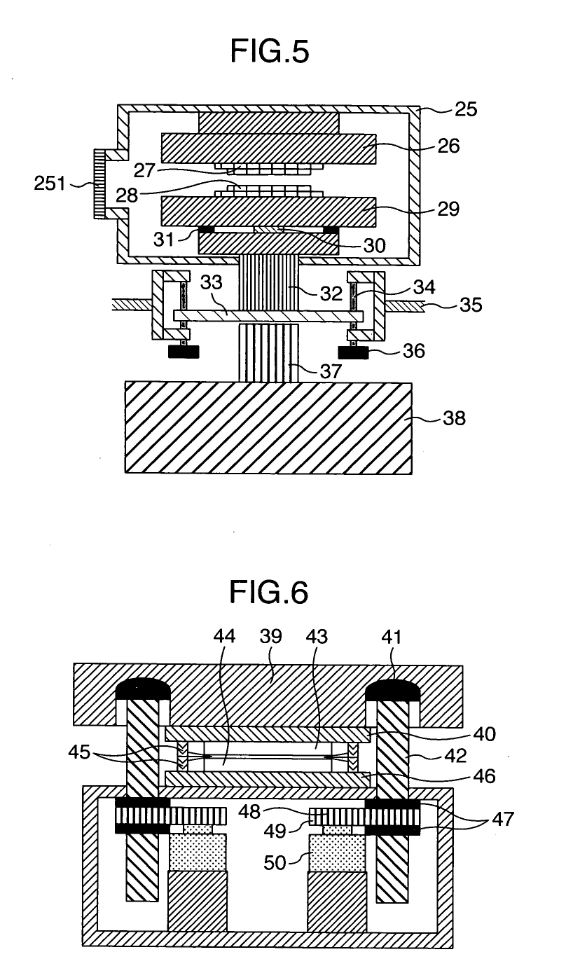

FIG. 5 shows a side cross sectional schematic view of a main portion of the pressurizing unit 6. The mold and the substrate which are finished alignment are integrally moved to the pressurizing unit 6 by the robot arm 2. In the pressurizing unit 6, the substrate/mold which are finished alignment are set on a stage side adapter 28 on a stage side heat block 29, after opening a vacuum chamber gate 251 for taking in and out the substrate and the mold in the vacuum chamber 25. Next, the vacuum chamber gate 251 is closed, a stage elevating drive motor 36 is thereafter driven, and a screw thread 34 is rotated.

Next, the stage elevating plate is moved upward, and is moved upward until the substrate/mold are in contact with a head side adapter 27 attached to a head side heat block 26 via a stage support column 32. In this case, since the stage side heat block 29 is held by a ball joint 30 and a parallelization degree keeping spring 31, a parallelization degree between the head side adapter 27 and the stage side adapter 28 is automatically adjusted. Next, an inner side of the vacuum chamber 25 is vacuum deaerated to a pressure equal to or less than 1 Pa.

Next, after energizing the head side heat block 26 and the stage side heat block 27 so as to heat to 200° C. by using an inductive heater, a nitrogen having a regulated pressure is introduced into an air press cylinder 38, a pressurizing rod 32 is moved upward, and the substrate/mold are pressurized. At this time, 600 kgf is first applied, and 3500 kgf is next applied, and is kept for three minutes. Next, the sample is cooled to 60° C. by circulating a cooling water in the head side heat block 26 and the stage side heat block 27. Next, the pressure is released, the vacuum chamber 25 is thereafter leaked, the vacuum chamber gate 251 is opened, and the substrate/mold are taken out by the robot arm.

The embodiment described above employs a two-stage pressurizing system comprising a first stage pressurization obtained by the screw thread 34 driven by the motor 36 and a sequential second stage pressurization obtained by the air cylinder 38, whereby it is possible to pressurize while keeping an accurate parallelization degree between the substrate surface and the mold.

FIG. 6 shows a side cross sectional schematic view of a main portion of the peeling unit 7. The substrate/mold passing through the pressurizing unit is moved to the peeling unit 7 by the robot arm. The substrate/mold are vacuum adsorbed and fixed to an adsorbing stage 46. Next, leading ends of peeling wedges 45 arranged at concentric positions at 120 degree on the stage are inserted to the substrate/mold interface. An adsorbing head 40 fixed to a head support plate 39 is moved downward, and a mold 43 is fixed to the heat support plate 39. Next, the leading end of the peeling wedge 45 in a side of the head is inserted to the substrate/mold interface in the same manner.

Next, three head elevating rods 42 are independently driven by stage elevating motors via stage elevating nuts and nut rotating gears, the head support plate 39 is tilted at 1 to 10 degree, and the mold 43 is peeled off from the substrate 44. At a time of peeling, a peeling speed, a peeling temperature and the like are monitored and controlled by the control unit 9. After peeling, the substrate 44 is moved to the processed goods carrying out rack 11 of the substrate carrying in and carrying out unit 3 by the robot arm 2.

Further, the mold 43 is stored in the mold rack 14 of the mold storing unit 4 by the robot arm 2. A continuous use number of the mold is counted by the control unit, and the mold in which the use number reaches a predetermined number is moved to the mold cleaning unit 8 from the peeling unit 7 and is cleaned.

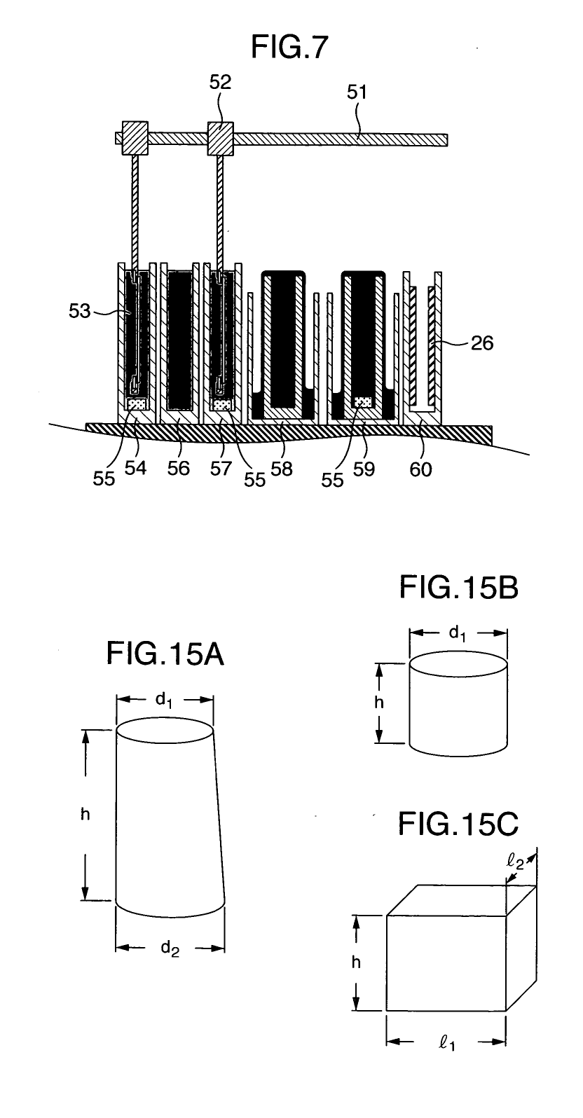

FIG. 7 shows a side cross sectional schematic view of a main portion of the mold cleaning unit. A used mold 53 used at the predetermined number is dipped into an N-methylpyrrolidone within an organic cleaning tank 54, and is organically cleaned by an ultrasonic wave vibrator 55 for five minutes. Next, the mold is dipped into a first organic rinse tank 56 filled with an isopropyl alcohol for two minutes, and is further rinsed in a second organic rinse tank filled with the isopropyl alcohol for two minutes while the liquid is vibrated by the ultrasonic wave vibrator 55.

Next, after being cleaned in a first flowing water washing tank 58 by a pure water for two minutes, the mold is cleaned by water washing in a second flowing water washing tank 59 for two minutes while the ultrasonic wave vibration is applied. Finally, a heating and drying is applied to the mold by an infrared ray lamp within a drying machine 60, and the mold is stored within the mold rack of the mold storing unit 4 after being finished. These steps are processed by the automatic movement of the mold conveying arm holding the mold 53 along the mold conveying guide.

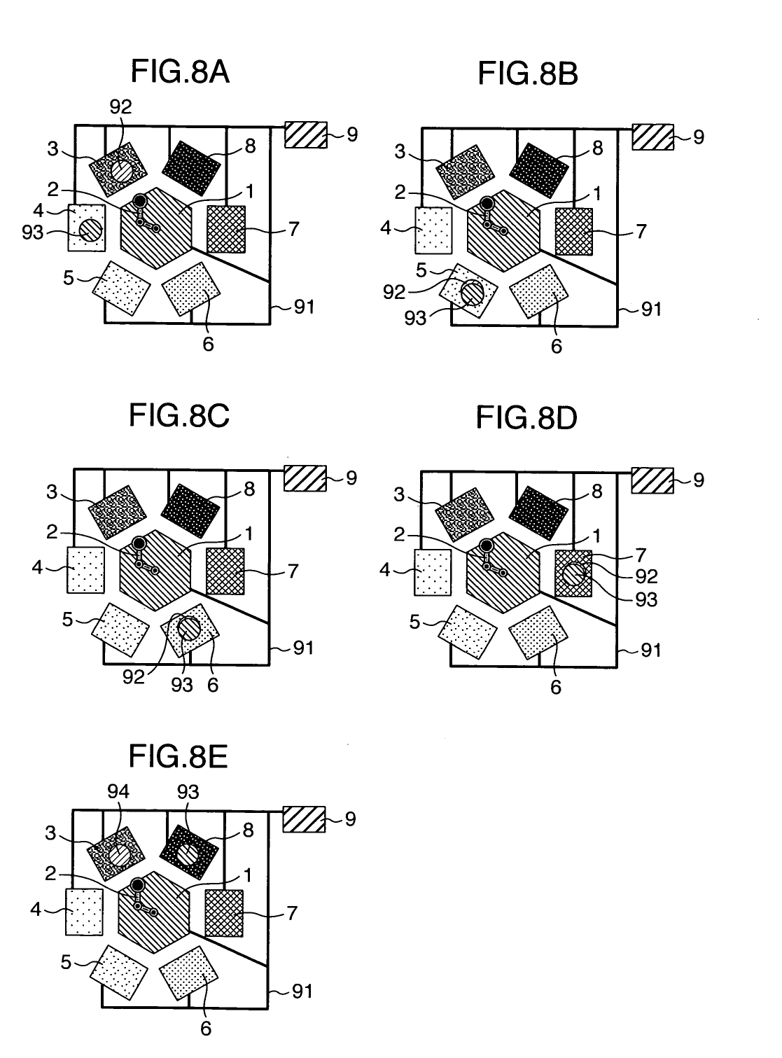

FIG. 8 shows a flow chart paying attention to a substrate 92 and a mold 93 shown in the present embodiment. The present flow chart is described for explanation in such a manner that only one set of substrate and mold are moved, however, plural sets of substrates/molds can be actually moved and processed simultaneously.

First, a substrate 92 in which the resin membrane is formed is moved from the substrate carrying in and carrying out unit 3 to the alignment unit 5 by the conveying robot arm 2 (FIG. 8A→FIG. 8B).

Next, a mold 93 is moved from the mold storing unit 4 to the alignment unit 5 by the robot arm 2 (FIG. 8B→FIG. 8C).

After alignment, the substrate 92 is moved to the pressurizing unit 6 in a state of mounting the mold 93 thereon so as to be pressurized and heated (FIG. 8C→FIG. 8D).

After cooling, the pressure is released, and the substrate 92 is moved to the peeling unit 7 in a state of being integrally lapped over the mold 92 (FIG. 8D→FIG. 8E).

After peeling the substrate 92 and the mold 93 by the peeling unit 7, a processed substrate 94 is moved to the substrate carrying in and carrying out unit 3, and the mold is moved to the mold cleaning unit 8. In this case, the mold is moved to the mold cleaning unit after peeling, however, in the case that the pollution is little, the mold may be directly moved to the mold storing unit 4.

The micro pattern is imprinted onto the silicone substrate by using the imprinting apparatus of the present invention in accordance with the steps mentioned above. The present imprinting apparatus simultaneously and continuously executes the alignment, pressurizing and peeling steps by using a plurality of molds and substrates.

In the case that the substrate surface is processed by the imprinting apparatus in accordance with the present invention, twelve sheets of substrates are prepared per one hour. Further, in the case that one of the imprinted patterns is evaluated in accordance with SEM observation, the defect-portion in the pattern is equal to or less than 10%.

### Embodiment 2

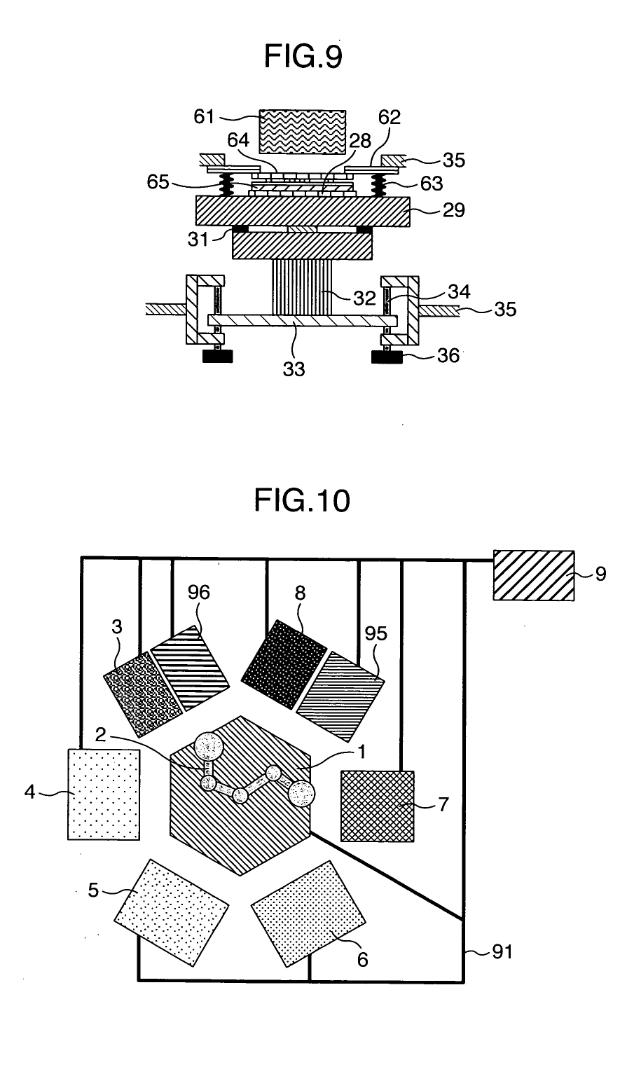

The same imprinting experiment as the embodiment 1 is executed by an imprinting apparatus using a photo cure type pressurizing unit shown in FIG. 9. In this case, the substrate employs a substrate obtained by applying PKA01 (produced by TOYO GOSEI) corresponding to a liquid photo cure type resin onto the silicone wafer having a diameter of 6 inchφ in accordance with a spin coat method.

A quartz mold 64 and a substrate 65 which are aligned by the alignment unit are moved to the stage side adapter 28 so as to be adsorbed. Next, an entire stage is moved upward by the stage elevating drive motor until the quartz mold 64 is in contact with a mold fixing jig 62 fixed to the frame 35 so as to pressurize and closely attach the substrate 65 and the quartz mold 64.

Next, an ultraviolet ray having a power of 1000 mJ/cm2 is irradiated by an ultraviolet ray lamp 61 on which an extra-high pressure mercury lamp is mounted. Next, the stage is moved downward, the sample in which the substrate and the quartz mold are closely attached is moved to the peeling unit, and they are peeled in accordance with the same step as that of the embodiment 1.

In the case that the substrate surface is processed by the imprinting apparatus in accordance with the present invention, thirty sheets of substrates are prepared per one hour. Further, in the case that the shape of one of the imprinted substrates is evaluated in accordance with SEM observation, the defect portion in the pattern is equal to or less than 10%.

### Embodiment 3

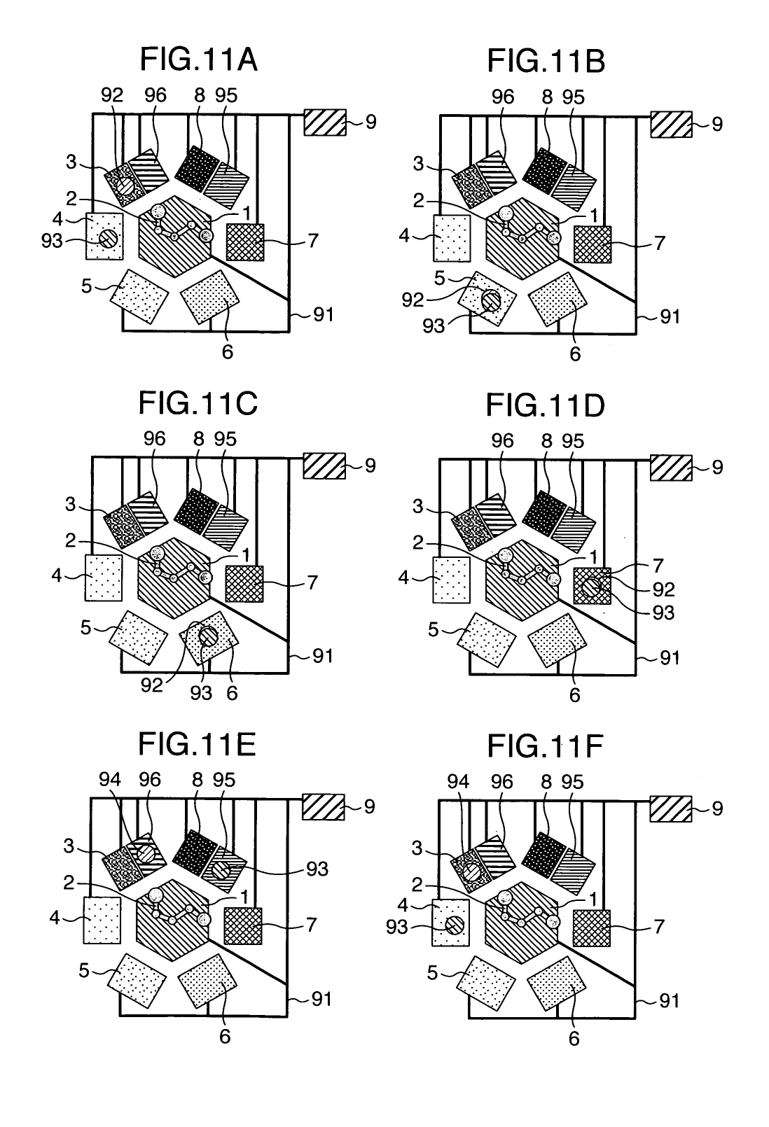

The same imprinting experiment as the embodiment 1 is executed by using an imprinting apparatus in which a mold inspecting unit 95 and a substrate inspecting unit 96 are added to the imprinting apparatus in accordance with the embodiment 1 shown in FIG. 10. In FIGS. 10 and 11, the same reference numerals as those in FIGS. 1 and 8 denote the same elements. FIG. 11 shows a flow chart paying attention to the movement of the metal mold substrate 92 and the mold 93 at that time. The present flow chart is described for explanation in such a manner that only one set of substrate and mold are moved, however, plural sets of substrates/molds are actually moved and processed simultaneously.

First, the substrate 92 in which the resin membrane is formed is moved from the substrate carrying in and carrying out unit 3 to the alignment unit 5 by the conveying robot arm 2 (FIG. 11A→FIG. 11B).

Next, the mold 93 is moved from the mold storing unit 4 to the alignment unit 5 by the robot arm 2 (FIG. 11A→FIG. 11B).

After alignment, the substrate 92 is moved to the pressurizing unit 6 in a state of mounting the mold 93 thereon so as to be pressurized and heated (FIG. 11B→FIG. 11C).

After cooling, the pressure is released, and the substrate 92 is moved to the peeling unit 7 in a state of being lapped over the mold 92 (FIG. 11C→FIG. 11D).

After peeling the substrate 92 and the mold 93 by the peeling unit 7, a processed substrate 97 is moved to a substrate inspecting unit 96, and the mold is moved to a mold inspecting unit 95. In the inspecting units, the pattern shapes of the mold and the processed substrate surface are inspected by using a blue laser microscope (FIG. 11D→FIG. 11E).

As a result of inspection, in the case that no defect is generated in the mold and the processed substrate, the processed substrate 94 is moved to the substrate carrying in and carrying out unit 3, and the mold is moved to the mold storing unit 4 (FIG. 11E→FIG. 11F).

The micro pattern is imprinted onto the silicone substrate by using the imprinting apparatus of the present invention in accordance with the steps mentioned above. The present imprinting apparatus simultaneously and continuously executes the alignment, pressurizing and peeling steps by using a plurality of molds and substrates.

In the case that the substrate surface is processed by the imprinting apparatus in accordance with the present invention, twelve sheets of substrates are prepared per one hour. Further, in the case that one of the imprinted patterns is evaluated in accordance with SEM observation, the defect portion in the pattern is equal to or less than 10%.

### Embodiment 4

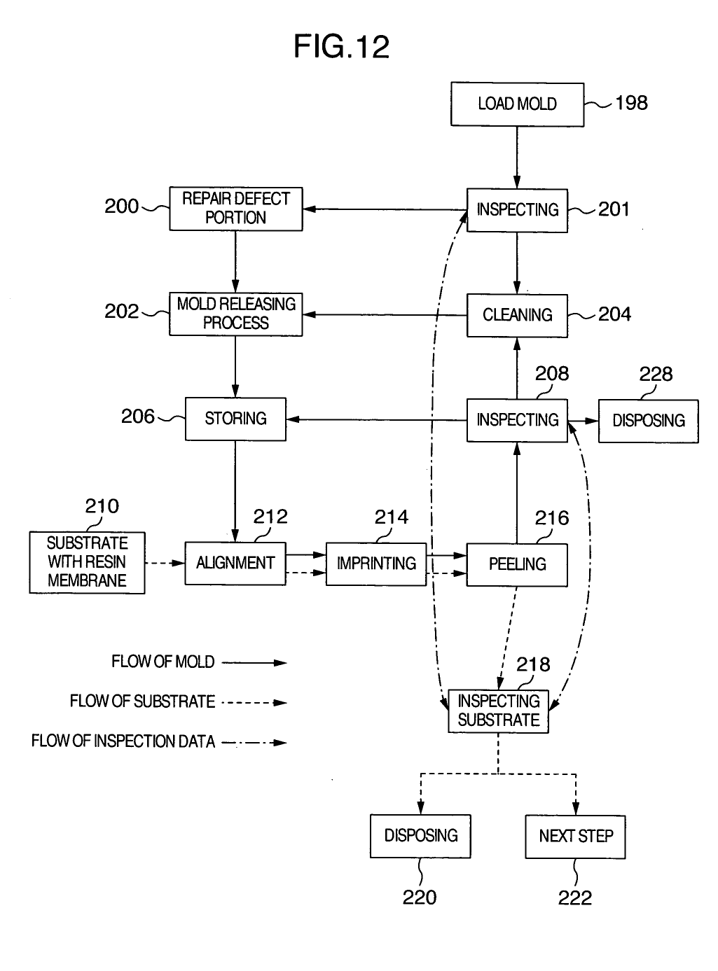

FIG. 12 is a flow chart schematically showing a flow of the mold, the substrate and the inspection data of the present imprinting apparatus. The pattern imprinting experiment is executed by using the same imprinting apparatus as that of the embodiment 3 (FIGS. 10 and 11) in accordance with the following method.

When checking the pattern shape of a loaded mold 198 made of Si and having a diameter of 6 inchφ and a thickness of 625 μm by a blue laser inspection 201, the process failure is partly generated and a groove having a width of 500 nm is not processed. Accordingly, the same groove process is executed by using a convergent ion beam and a repair 200 of the mold is executed. In the same manner, since a pattern loss of 200 nm×500 nm is generated, the loss portion is repaired by irradiating a gallium convergent ion beam while introducing a carbon contained gas. Further, since the defect beyond repair is found in the other two positions, the position data of the unit including the defects is registered in the control unit in the entire of the present imprinting apparatus. Further, ID number is incused on the mold loaded in the inspecting step and the ID number is simultaneously registered.

Next, after dipping in a fluorine mold releasing agent AQUAFORB (produced by GELEST Co. Ltd) diluted to 1%, the mold is dried and applied to a mold releasing process 202. The mold is stored 206 in the rack of the mold storing unit.

Next, in order to imprint the pattern onto a substrate 210 with the resin membrane in which a polystyrene resin having a thickness of 100 nm is applied onto a Si wafer having a diameter of 6 inchφ, an alignment process 212, an imprinting process 214 and a peeling process 216 are executed under the same condition as the embodiment 1.

Next, the inspection is executed with respect to the mold peeled from the substrate with the resin membrane. The inspection is executed by the blue laser microscope. At this time, the data of the unit including the defect is previously referred in the inspection at a time of loading, and the unit is taken off from the region to be inspected.

An inspection 218 of the substrate impressed in parallel to the inspection of the mold is simultaneously executed by the blue laser microscope. At this time, the defect unit is previously taken off from the inspection region as the defect unit by referring to the inspection data at a time of loading the mold. Since the defect of the resin membrane is found in a part of the imprinted pattern as a result of the inspection, the unit is defined as the defect unit, and the position data of the defect unit is registered in the control unit. In the case that a predetermined mold is not obtained even by the repairing work, the mold is disposed 228.

The data output from the imprinted substrate is also transferred to the mold inspecting unit. As a result of rechecking 208 the unit within the mold corresponding to the unit having the defect resin membrane in detail, a trace quantity of resin attachment is detected. Accordingly, the mold is fed to the mold cleaning unit 204 so as to be cleaned.

As mentioned above, the inspection region can be limited by making good use of the inspection data between the mold inspecting unit and the substrate inspecting unit, and the loading mold inspecting unit in common. Accordingly, the inspection time can be shortened, and it is possible to improve the repeated defect caused by the resin attached to the mold surface at a time of imprinting.

### Embodiment 5

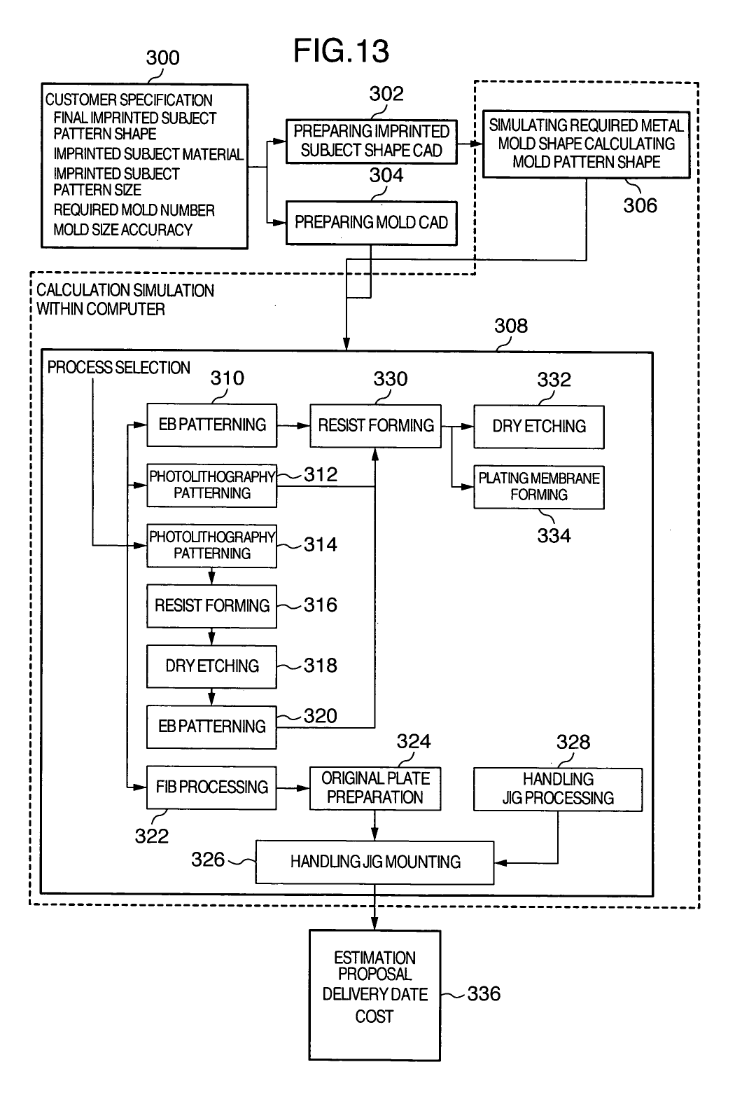

FIG. 13 shows a system scheme for manufacturing and receiving an order of the mold used in the imprinting method in accordance with the present invention. First, there are got from a customer a required specification such as an imprinting pattern shape to be formed by an imprinting, an imprinting subject material, an imprinting subject pattern size, a prepared number and the like. A method of getting the required specification includes a personal interview with the customer, and a method of inputting to a template in a home page such as an internet 300 or the like.

Next, in the case that a shape of a final imprinting subject is designated, a CAD drawing 302 of the final imprinting subject shape is prepared, and a simulation of a mold shape for achieving the final imprinting subject shape is executed by a computer on the basis of the data. At this time, since the final imprinting subject shape is on the nanometer scale, the computer calculates a pattern drawing (FIG. 14C) corresponding to a phenomenon which will be generated at an imprinting time which is peculiar to the nanometer scale, a roughness of the mold end portion generated at the mold preparing time which is negligible in the micron scale, and a resin filling property into the nanometer scale mold pattern on the basis of a finite element method, a concavo-convex shape of the mold for achieving the final imprinting subject shape is computed, and the required specification is considered, whereby a selection of the mold processing process is simulated. The processing method of the mold is selected by the computer from the data base which is previously prepared while taking into consideration the matching with the material, the size accuracy, the processing cost and the like.

A judging standard at a time of selecting the process is as follows. The mold structured from the pattern in which the minimum size of the pattern is equal to or less than about 200 nm is obtained by forming the resist pattern using the electron beam, and thereafter processing the mold original plate in accordance with a dry etching directly in the case that the prepared mold is constituted by a single mold, or thereafter preparing a plurality of replicas from the resist pattern or the dry etched mold master in accordance with a Ni plating in the case that the prepared mold is constituted by a plurality of molds. In the case that the minimum size of the mold is equal to or more than about 200 nm, the resist pattern is prepared on the Si substrate in accordance with a photolithography process, and the mold original plate is prepared on the basis of the same standard as that of the case that the minimum pattern size is equal to or less than 200 nm.

In the case that the portion having the pattern size equal to or more than 200 nm and the portion having the pattern size equal to or less than 200 nm are mixed, the portion equal to or more than 200 nm is processed in accordance with the photolithography process, and the portion equal to or less than 200 nm is thereafter dry etched after the resist process in accordance with an electron beam direct drawing method 320, whereby the original plate is formed, or in the case that a plurality of plates are required, the mold master is formed, and the replica is prepared in accordance with the Ni plating. In the case that the pattern size forming area is equal to or less than some mm and the required mold number is about one, the mold original plate is obtained by directly processing Si by the convergent ion beam. In the above description, the dry etching is applied at a time of processing the Si substrate, however, since the roughness of the processing end portion is restricted by applying an anisotropic etching on the basis of a wet process and it is possible to process at a very high accuracy, the etching method is considered in correspondence to the required specification. Finally, a mold delivery date and cost are calculated on the basis of the simulation, and are proposed to the customer.

It is possible to propose the delivery date and the cost at a very high accuracy by estimating the mold preparation for imprinting the ultra fine shape on the basis of the scheme mentioned above. Further, the working amount of the mold preparing line is included in the calculation date at a time of calculating the delivery date estimation, it is possible to intend to average the working amount on the line, and it is possible to contribute to an increase of a line operating efficiency.

The above description shows the scheme in the case that the imprinted subject shape is proposed by the customer, however, in the case of using the present system, it is possible to select the process and calculate the estimation of the delivery date and the cost while taking into consideration the metal mold shape, the size accuracy, the required number and the like even in the case that the metal mold shape is directly designated.

As an example of a field to which the nanometer print using the imprinting apparatus in accordance with the present invention, there is a biological chip used for immunodiagnosis. A flow path made of the glass and having a substrate depth of 3 micrometer and a width of 20 micrometer is formed therein. The structure is made such as to introduce a specimen including a deoxyribo nucleic acid (DNA), a blood, a protein and the like from an introduction hole, flow through a flow path 902 and thereafter flow to a discharge hole. A projection assembly having a diameter 250 nm to 300 nm and a height of 3 μm is formed in a molecular filter. The other applied examples of the present invention include a multilayer interconnection board, a magnetic disc, an optical waveguide and the like. All of them belong to a nanotechnology using the micro and nanometer size structure having the submicron size.

The main embodiments in accordance with the present invention are summarized as follows.
(1) A micro and nanometer size structure imprinting method comprising:
   a step of contacting and pressurizing a mold having a micro concavo-convex structure formed on a surface thereof onto a substrate having a surface made of a material capable of keeping a plasticity as occasion demands so as to imprint the micro concavo-convex structure to the surface; and
   a step of peeling the mold from the surface,
   wherein the mode and the substrate are integrally moved between the steps, preferably by a robot.
(2) A method, wherein the material is held on the substrate surface.
(3) A method, wherein the material is constituted by a photo cure type resin composition material.
(4) A method, wherein the material is constituted by a thermoplastic resin.
(5) A micro and nanometer size structure imprinting method having a step of heating the material formed on the substrate to a softening point or a glass transition temperature or more so as to keep the plasticity of the material prior to the imprinting step.
(6) A micro and nanometer size structure imprinting method, wherein at least a part of the mold has a light permeability, the resin composition material is cured by photoirradiating after pressurizing of the mold to the photo cure type resin composition material held on the substrate and irradiating the light via the mold, and thereafter the mold is peeled from the composition material.
(7) A micro and nanometer size structure imprinting method, wherein at least a part of the mold has a light permeability, the resin composition material is cured by photoirradiating after pressurizing of the mold to the photo cure type resin composition material held on the substrate and irradiating the light via a light permeable portion of the mold, and thereafter a development is executed by removing an uncured portion.
(8) An imprinting apparatus comprising:
   a contacting and holding means for contacting and holding a mold having a micro concavo-convex structure on a surface thereof onto a substrate surface having a material capable of keeping a plasticity as occasion demands;
   a pressurizing means for applying a pressure to a contact surface between the mold and the substrate; and
   a peeling means for peeling the mold from the substrate surface,
   wherein the mold and the substrate are integrally separated from the contacting and holding means, the pressurizing means and the peeling means at a time of moving the mold and the substrate from the pressurizing means to the peeling means.
(9) An imprinting apparatus comprising:
   an alignment unit for determining a relative position between a substrate and a mold;
   a pressurizing unit for pressurizing the substrate and the mold;
   a peeling unit for peeling the mold from the substrate;
   a storing unit for storing the mold;
   a carrying in and carrying out unit for carrying in and carrying out the substrate;
   an inspection unit of the metal mold and the imprinted substrate; and
   a robot for conveying the mold and the substrate between the respective units.
(10) An apparatus, wherein two or more units constituting the imprinting apparatus are arranged on the periphery of the conveying apparatus.
(11) An apparatus, wherein a plurality of molds having different patterns are stored in the storing unit.
(12) An apparatus, wherein the pressurizing unit has a heating mechanism.
(13) An apparatus, wherein the pressurizing unit has a light irradiating mechanism.
(14) An apparatus, wherein the mold is made of a metal or an inorganic material.
(15) An apparatus, wherein a minimum size of the micro concavo-convex structure of the mold is equal to or more than some nm, and a maximum size is equal to or less than 100 μm.
(16) An imprinting apparatus comprising:
   an imprinting unit for contacting and pressurizing a mold having a micro concavo-convex structure formed on a surface thereof onto a substrate surface;
   an alignment unit for determining a relative position between the substrate and the mold;
   a pressurizing unit for pressurizing the substrate and the mold;
   a peeling unit for peeling the mold from the substrate;
   a storing unit for storing the mold;
   a carrying in and carrying out unit for carrying in and carrying out the substrate; and
   an inspecting unit for inspecting the mold before being used, after being used and after being cleaned or any one of them.
(17) An apparatus having a control apparatus for controlling such that two or more sets of molds and substrates are processed by the different units simultaneously or in a temporarily overlapped manner.
(18) An imprinting apparatus comprising:
   an alignment unit for determining a relative position between the mold in which a micro concavo-convex structure is formed on a surface and the substrate;
   a peeling unit for peeling the mold from the substrate;
   a storing unit for storing the mold;
   a carrying in and carrying out unit for carrying in and carrying out the substrate;
   an inspecting unit for inspecting the substrate; and
   an inspecting unit for inspecting the mold,
   wherein the imprinting apparatus is provided with a control apparatus for controlling such that two or more sets of molds and substrates are processed by the different units simultaneously or in a temporarily overlapped manner, or in a temporarily non-overlapped manner.
(19) An apparatus, wherein a display or a data for identification is described or incused on the mold in which the micro concavo-convex structure is formed on the surface.
(20) An imprinting apparatus comprising:
   an imprinting unit for contacting and pressurizing a mold having a micro concavo-convex structure formed on a surface thereof onto a substrate surface capable of keeping a plasticity;
   an elevating unit for sliding a stage portion on which the mold or the substrate is mounted; and
   a pressurizing unit for applying a load to the substrate and the mold,
   wherein the imprinting apparatus has a motor driving the elevating mechanism, and an air cylinder driving the pressurizing mechanism.
(21) An apparatus, wherein the unit for inspecting the substrate and the unit for inspecting the mold have the respective inspection results in common.
(22) An imprinting apparatus comprising:
   an imprinting unit for contacting and pressurizing a transparent mold having a micro concavo-convex structure formed on a surface thereof onto a film surface of a substrate holding the film of a photo cure type resin composition material;
   an elevating unit for sliding a stage portion on which the mold or the substrate is mounted; and
   a pressurizing unit for applying a load to the substrate and the mold,
   wherein the imprinting apparatus has a motor driving the elevating mechanism, an air cylinder driving the pressurizing mechanism, and a light irradiating apparatus exposing a predetermined light in a state in which the mold and the film are contacted and pressurized via the transparent mold.
(23) An apparatus, wherein the elevating unit is constituted by a screw thread shaft and a nut attached to a stage portion engaged with the screw thread shaft, and the stage portion is slid by rotating the screw thread portion by an electric motor.
(24) An apparatus, wherein the elevating mechanism is constituted by two or more screw thread shafts, and the nuts attached to the stage portion engaged therewith, and the stage portion is slid by rotating the screw thread shaft by the electric motor.
(25) An apparatus, wherein the pressurizing mechanism pressurizes to a predetermined pressure on the basis of at least two stages of steps.
(26) An apparatus having a unit for imaging a position of the concavo-convex structure formed in the mold by a CCD camera and aligning the mold with respect to the substrate having a material surface having a plasticity on the basis of the image.
(27) An apparatus having a mechanism of inserting a wedge to an interface between the mold and the substrate in order to peel off the mold from the substrate having a material surface having a plasticity.
(28) An apparatus further provided with a plurality of cleaning containers so as to receive a plurality of cleaning liquids.
(29) An apparatus provided with a means for pressurizing a mold having a micro concavo-convex structure and made of a transparent material to a substrate to which a photo cure type resin composition material film is attached, and exposing the film by irradiating a light from a light source in this state.
(30) An apparatus having an inspecting apparatus for inspecting a loaded mold, a mold peeled from a substrate having a surface having a plasticity, a cleaned mold and a repaired mold.
(31) A method of determining whether or not to manufacture a target mold, by selecting at least a manufacturing method and a material of a mold from a previously accumulated data base on the basis of a shape of a micro concavo-convex structure formed in the mold and a used environment of the mold, arithmetically operating a manufacturing cost of the mold and a shape of a micro columnar projection group manufactured by the mold by a computer on the basis of the result and outputting the results of arithmetic operation, at a time of contacting and pressurizing the mold having a micro concavo-convex structure formed on a surface thereof to a substrate having a surface capable of maintaining a plasticity so as to imprint the micro concavo-convex structure.
(32) A method, wherein a mold processing method is selected on the basis of at least a size and a produced number of the micro concavo-convex structure on the surface.
(33) A method, wherein the imprinting step includes a step of forming a resist pattern on an original plate of the mold, a step of forming a pattern on the original plate in accordance with an etching, and a step of peeling the resist pattern.
(34) A method of manufacturing a micro columnar projection group, wherein the step of forming the resist pattern includes a direct drawing method by an electron beam, a photolithography method or a step obtained by combining them.
(35) A method, wherein the imprinting method includes a step of directly processing the original plate of the mold in accordance with a focus ion beam method.
(36) A method, wherein the imprinting method includes a step of preparing a copy in accordance with a plating method on the basis of an original plate formed by a dry etching or an original plate formed by a focus ion beam.

It should be further understood by those skilled in the art that although the foregoing description has been made on embodiments of the invention, the invention is not limited thereto and various changes and modifications may be made without departing from the spirit of the invention and the scope of the appended claims.

1. A micro and nanometer size structure imprinting method comprising:
a step of contacting and pressurizing a mold having a micro concavo-convex structure formed on a surface thereof onto a substrate having a surface made of a material capable of keeping a plasticity as occasion demands so as to imprint said micro and nanometer size concavo-convex structure to said surface; and
a step of peeling said mold from said surface,
wherein said mold and said substrate are moved while in contact with one another between said steps.

2. A micro and nanometer size structure imprinting method as claimed in claim 1, wherein the method further comprises a step of heating the material formed on said substrate to a glass transition temperature or more so as to keep the plasticity of said material prior to said imprinting step.

3. A micro and nanometer size structure imprinting method as claimed in claim 1, wherein said mold has a light permeability, said resin composition material is cured by photoirradiating after pressurizing of said mold to the photo cure type resin composition material held on said substrate and irradiating the light via said mold, and thereafter said mold is peeled from said composition material.

4. A micro and nanometer size structure imprinting method as claimed in claim 1, wherein at least a part of said mold has a light permeability, said resin composition material is cured by photoirradiating after pressurizing of said mold to the photo cure type resin composition material held on said substrate and irradiating the light via a light permeable portion of said mold, and thereafter a development is executed by removing an uncured portion.

5. An imprinting apparatus comprising:
a contacting and holding means for contacting and holding a mold having a micro and nanometer size concavo-convex structure on a surface thereof onto a substrate surface having a material capable of keeping a plasticity as occasion demands;
a pressurizing means for applying a pressure to a contact surface between said mold and the substrate; and
a peeling means for peeling said mold from the substrate surface,
wherein said mold and the substrate are in contact with one another in said contacting and holding means, the pressurizing means and at a time of moving said mold and the substrate from said pressurizing means to the peeling means which separates said mold and the substrate from one another.

6. An imprinting apparatus comprising:
an alignment unit for determining a relative position between a substrate and a mold;
a pressurizing unit for pressurizing the substrate and the mold;
a peeling unit for peeling the mold from the substrate;
a storing unit for storing the mold;
a carrying in and carrying out unit for carrying in and carrying out the substrate;
an inspection unit of the metal mold and the imprinted substrate; and
a conveying unit for conveying said mold and the substrate between the respective units.

7. An imprinting apparatus as claimed in claim 6, wherein a minimum size of the micro and nanometer size concavo-convex structure of said mold is equal to or more than some nm, and a maximum size is equal to or less than 100 mm.

8. An imprinting apparatus comprising:
an imprinting unit for contacting and pressurizing a mold having a micro and nanometer size concavo-convex structure formed on a surface thereof onto a substrate surface;
an alignment unit for determining a relative position between the substrate and the mold;
a pressurizing unit for pressurizing the substrate and the mold;
a peeling unit for peeling the mold from the substrate;
a storing unit for storing the mold;
a carrying in and carrying out unit for carrying in and carrying out the substrate; and
an inspecting unit for inspecting the mold before being used, after being used and after being cleaned.

9. An imprinting apparatus as claimed in claim 8, wherein the imprinting apparatus further comprises a control apparatus for controlling such that two or more sets of molds and substrates are processed by the different units simultaneously.

10. An imprinting apparatus comprising:
an alignment unit for determining a relative position between the mold in which a micro and nanometer size concavo-convex structure is formed on a surface and the substrate;
a peeling unit for peeling the mold from the substrate;
a storing unit for storing the mold;
a carrying in and carrying out unit for carrying in and carrying out the substrate;
an inspecting unit for inspecting the substrate; and
an inspecting unit for inspecting the mold,
wherein the imprinting apparatus is provided with a control apparatus for controlling such that two or more sets of molds and substrates are processed by the different units.

11. An imprinting apparatus as claimed in claim 10, wherein a display or a data for identification is described or incused on the mold in which the micro and nanometer size concavo-convex structure is formed on said surface.

12. An imprinting apparatus comprising:
an imprinting unit for contacting and pressurizing a mold having a micro and nanometer size concavo-convex structure formed on a surface thereof onto a substrate surface capable of keeping a plasticity;
an elevating unit for sliding a stage portion on which the mold or the substrate is mounted; and
a pressurizing unit for applying a load to the substrate and the mold,
wherein the imprinting apparatus has a motor driving said elevating mechanism, and an air cylinder driving said pressurizing mechanism.

13. An imprinting apparatus comprising:
an imprinting unit for contacting and pressurizing a transparent mold having a micro and nanometer size concavo-convex structure formed on a surface thereof onto a film surface of a substrate holding the film of a photo cure type resin composition material;
an elevating unit for sliding a stage portion on which the mold or the substrate is mounted; and
a pressurizing unit for applying a load to the substrate and the mold,
wherein the imprinting apparatus has a motor driving said elevating mechanism, an air cylinder driving said pressurizing mechanism, and a light irradiating apparatus exposing a predetermined light in a state in which the mold and said film are contacted and pressurized via said transparent mold.

14. An imprinting apparatus as claimed in claim 13, wherein said elevating unit is constituted by a screw thread shaft and a nut attached to a stage portion engaged with the screw thread shaft, and the stage portion is slid by rotating the screw thread portion by an electric motor.

15. An imprinting apparatus as claimed in claim 13, wherein said elevating mechanism is constituted by two or more screw thread shafts, and the nuts attached to the stage portion engaged therewith, and the stage portion is slid by rotating the screw thread shaft by the electric motor.

16. An imprinting apparatus as claimed in claim 13, wherein said pressurizing mechanism pressurizes to a predetermined pressure on the basis of at least two stages of steps.

17. An imprinting apparatus as claimed in claim 13, wherein the imprinting apparatus further comprises a unit for imaging a position of the concavo-convex structure formed in the mold by a CCD camera and aligning the mold with respect to the substrate having a material surface having a plasticity on the basis of the image.

18. An imprinting apparatus as claimed in claim 13, wherein the imprinting apparatus further comprises a mechanism of inserting a wedge to an interface between the mold and the substrate in order to peel off the mold from the substrate having a material surface having a plasticity.

19. An imprinting apparatus as claimed in claim 13, wherein the imprinting apparatus is further provided with a plurality of cleaning containers so as to receive a plurality of cleaning liquids.

20. An imprinting apparatus as claimed in claim 13, wherein the imprinting apparatus is further provided with a means for pressurizing a mold having a micro and nanometer size concavo-convex structure and made of a transparent material to a substrate to which a photo cure type resin composition material film is attached, and exposing said film by irradiating a light from a light source in this state.

21. An imprinting apparatus as claimed in claim 13, wherein the imprinting apparatus further comprises an inspecting apparatus for inspecting at least one of a loaded mold, a mold peeled from a substrate having a surface having a plasticity, a cleaned mold and a repaired mold.

22. A method of determining whether or not to manufacture a target mold, by selecting at least a manufacturing method, a material and a size of a mold from a previously accumulated data base on the basis of a shape of a micro and nanometer size concavo-convex structure formed in said mold and a used environment of said mold, arithmetically operating a manufacturing cost of the mold and a shape of a micro columnar projection group manufactured by the mold by a computer on the basis of the result and outputting the results of arithmetic operation, at a time of contacting and pressurizing said mold having a micro and nanometer size concavo-convex structure formed on a surface thereof to a substrate having a surface capable of maintaining a plasticity so as to imprint said micro concavo-convex structure.

23. A method as claimed in claim 22, wherein said imprinting step includes a step of forming a resist pattern on an original plate of the mold, a step of forming a pattern on the original plate in accordance with an etching, and a step of peeling the resist pattern.

24. A method as claimed in claim 22, wherein the step of forming said resist pattern comprises a direct drawing method by an electron beam, a photolithography method or a step obtained by combining them.

25. A method as claimed in claim 22, wherein said imprinting method comprises a step of directly processing the original plate of the mold in accordance with a focus ion beam method.

26. A method as claimed in claim 22, wherein said imprinting method comprises a step of preparing a copy in accordance with a plating method on the basis of an original plate formed by a dry etching or an original plate formed by a focus ion beam.
